(19) United States
(12) Patent Application Publication
(10) Pub. No.: US 2025/0364763 A1
(43) Pub. Date: Nov. 27, 2025

(54) USB SOCKET

(71) Applicant: Yunhua Lin, Yueqing City (CN)

(72) Inventor: Yunhua Lin, Yueqing City (CN)

(21) Appl. No.: 18/672,025

(22) Filed: May 23, 2024

(51) Int. Cl. H01R 13/74; H01R 13/502; H01R 25/00; H01R 27/02

(52) U.S. Cl. CPC H01R 13/74; H01R 13/502; H01R 25/006; H01R 27/02

(57) ABSTRACT

A universal serial bus (USB) socket includes a housing, a fixation plate, a mounting plate and a USB interface. The fixation plate is fixed on the housing. The USB interface is mounted on the mounting plate. A jack matching the USB interface is provided on a face plate of the housing. The mounting plate is connected to the fixation plate, such that the mounting plate is connected to an upper portion of a cavity of the housing. A printed circuit board is arranged in the cavity of the housing. The USB socket further includes a component connected to the printed circuit board. The fixation is configured to fix the socket, the mounting plate configured to fix the USB interface is connected to the fixation plate, and the fixation plate is fixed or clamped on the housing, such that assembly and mounting are convenient.

### TECHNICAL FIELD

The present disclosure relates to a universal serial bus (USB) socket.

### BACKGROUND

Electronic devices are popularized nowadays. As a representative, a mobile phone has been applied in not only call, but also payment, travel, catering and other aspects of daily life. Such electronic devices cannot be separated from modern society. As functions of the electronic devices such as the mobile phone are expanded, power consumption is increased. It is quite common to charge an electronic device once a day. People are likely to be confronted with no power at some time. Thus, an increasing demand for charging these electronic products at home and in public places is provided. However, people cannot always find corresponding chargers.

In some public places and families, fixed sockets having a universal serial bus (USB) interface are used for convenient charging. In the prior art, for example, the China patent with the publication patent number of CN 215732574 U discloses a socket having a Type-C interface, which integrates a USB charging interface into a common power socket. In the prior art, a mounting plate is included and required to be fixed on a housing, and two fixation plates are symmetrically arranged on the socket to mount the fixed socket in a mounting box reserved on a wall. An assembly process is complex.

### SUMMARY

In order to overcome the above shortcomings, an objective of the present disclosure is to provide a fixed USB socket convenient to mount.

Therefore, a universal serial bus (USB) socket in the present disclosure includes a housing, a fixation plate, a mounting plate and a USB interface. The fixation plate is fixed on the housing. The USB interface is mounted on the mounting plate. A jack matching the USB interface is provided on a face plate of the housing. The mounting plate is connected to the fixation plate, such that the mounting plate is connected to an upper portion of a cavity of the housing. A printed circuit board is arranged in the cavity of the housing below the mounting plate.

Further, the fixation plate includes a longitudinal support plate. The longitudinal support plate is L-shaped. The longitudinal support plate is arranged on an inner side of an inner wall of the housing. An end of the mounting plate is erected on a flange of the longitudinal support plate.

Further, the fixation plate includes a longitudinal connection plate. The longitudinal connection plate is provided with a hole to be fixed to the housing by means of a bolt.

Further, the USB interfaces include 2 Type-C interfaces and 2 USB-A interfaces. The USB interfaces are distributed in a single row in a length direction of the face plate of the socket. A length direction of the USB interface is parallel to a width direction of the face plate of the socket.

Further, the fixation plate includes wing plates arranged at two ends and a web strip connecting the wing plates at the two ends. Each wing plate extends out of the housing and is provided with several holes. The web strip is arranged on one side or two sides of the USB interfaces.

Further, a fixation strip is connected to the web strip. The mounting plate is fixedly connected to the fixation strip.

Further, the fixation strip and the mounting plate are provided with corresponding holes. Bolts pass through the holes on the mounting plate and the fixation strip for fixation. A fixation ring is arranged between the mounting plate and the fixation strip. The fixation ring is in threaded connection to the bolts. An upper surface of the fixation ring is in clamped fit with a lower surface of the fixation strip. A lower surface of the fixation ring is clamped fit with an upper surface of the mounting plate.

Further, the housing includes an upper cover and a base detachably fixed to the upper cover. A recess is formed on the upper cover. A baffle matching the recess is arranged on the base. The fixation plate is arranged between the recess and the baffle.

Further, the base includes a bottom plate. A plurality of heat emission holes are provided on the bottom plate and a wall plate of a lower side of the base. The printed circuit board is mounted in the cavity in a suspended manner. The printed circuit board is spaced apart from the bottom plate by a predetermined length.

The USB socket further includes a component connected to the printed circuit board. A gap is provided between the component and the mounting plate. Beneficial effects of the present disclosure are as follows:
1. The fixation plate in the present disclosure is configured to fix the socket in the mounting groove reserved in the wall, the mounting plate configured to fix the USB interface is connected to the fixation plate, and the fixation plate is fixed or clamped on the housing, such that assembly and mounting are convenient.
2. In a particular example of the present disclosure, the fixation plate includes wing plates partially extending out of the housing, two ends of the housing are each provided with a wing plate, and the wing plates are connected by a web strip having a small width. A fixation strip is arranged on the web strip. A longitudinal support plate is further arranged below the fixation plate, and the entire longitudinal support plate is L-shaped. Two ends of a mounting plate are erected on a flange of the longitudinal support plate such that fixation can be performed without a bolt. A hole is provided in a middle of the mounting plate, the mounting plate is fixed to the fixation strip of the web strip by means of a bolt and a fixation ring, and the mounting plate and the interface do not loose.
3. In a particular example of the present disclosure, a plurality of strip-shaped heat emission holes are provided. Certain gaps are reserved between a printed circuit board and component, and a bottom plate and a mounting plate. A heat-conducting structure may be pre-arranged in a mounting groove of the socket to reduce heat generated by the USB interface, such that safety is ensured and charging power is increased.

### BRIEF DESCRIPTION OF THE DRAWINGS

FIG. 1 is a schematic top view of a particular example implementing the present disclosure;

FIG. 2 is a schematic exploded view of some components in FIG. 1;

FIG. 3 is a schematic top view of a base;

FIG. 4 is a schematic sectional view of FIG. 1;

FIG. 5 is a schematic diagram of Example 2 of a fixation plate.

### DETAILED DESCRIPTION OF THE EMBODIMENTS

In order to further illustrate technical means for realizing an intended objective of the present disclosure and technical effects, particular embodiments, structures and features according to the present disclosure and their effects are described in detail hereinafter in combination with accompanying drawings and preferred examples.

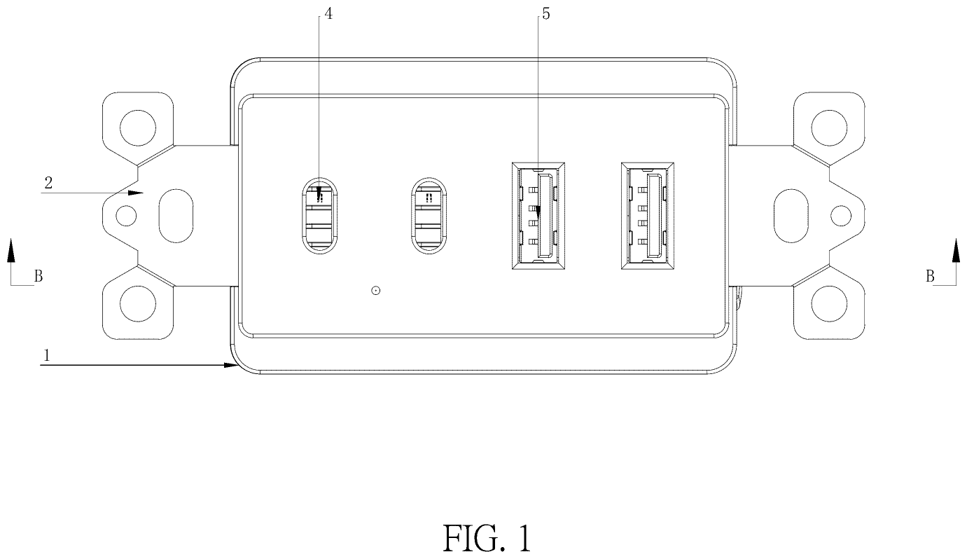

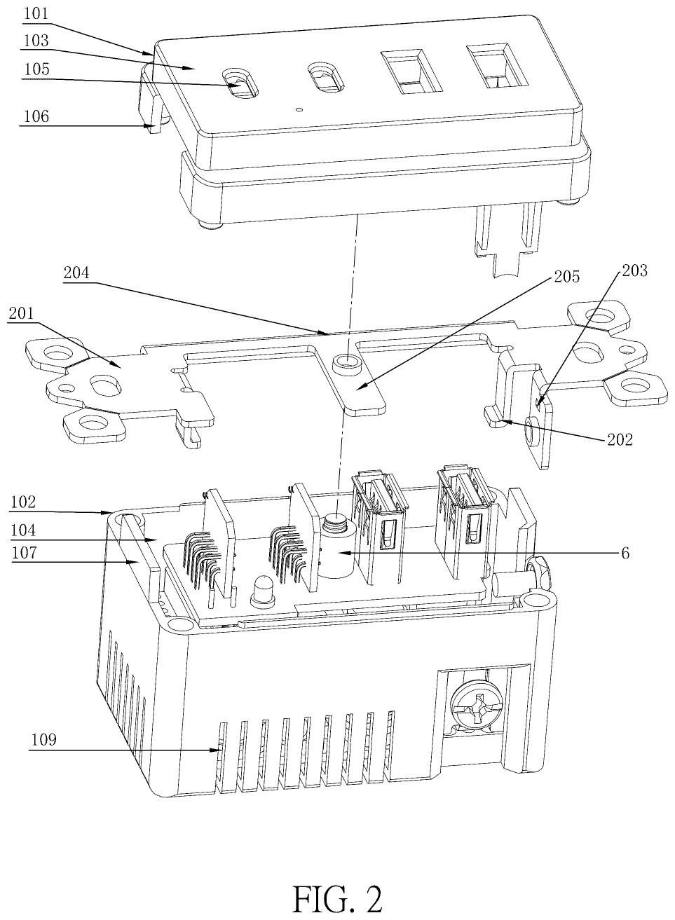

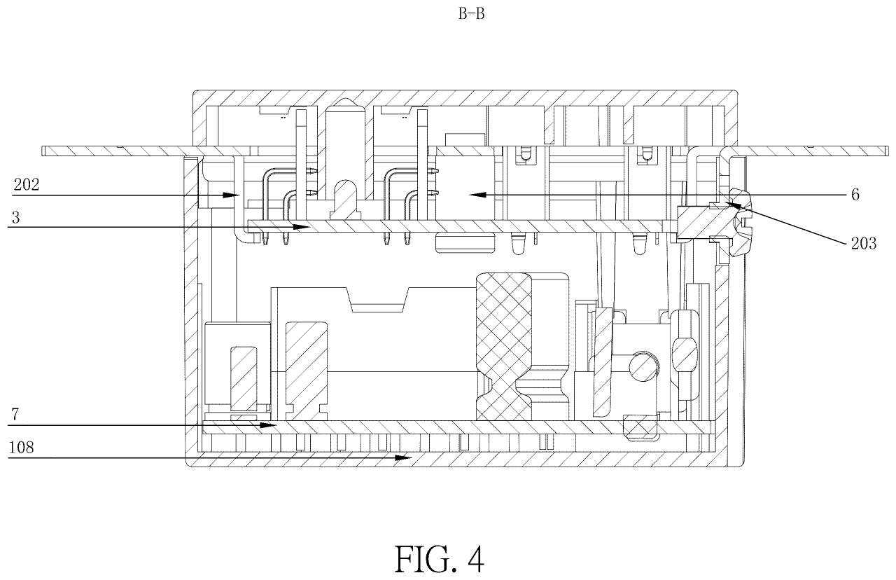

With reference to FIGS. 1-4, a universal serial bus (USB) socket in the present disclosure includes a housing 1, a fixation plate 2, a mounting plate 3 and a USB interface. The fixation plate 2 is fixed on the housing 1. The mounting plate 3 is connected to the fixation plate 2 such that the mounting plate 3 is connected to an upper portion of a cavity 104 of the housing 1. A printed circuit board (PCB) 7 is arranged in the cavity 104 of the housing 1 below the mounting plate 3. The USB interface is mounted on the mounting plate 3. A jack 105 matching the USB interface is provided on a face plate 103 of the housing 1. With reference to FIG. 1, the housing 1 of the USB socket in the example includes an upper cover 101 and a base 102. The upper cover 101 and the base 102 may be fixed in a detachable connection manner such as bolt connection or clamping. The upper cover 101 includes a face plate 103, and may further include a decorative plate and a wear-resisting plate. The face plate 103 is provided with 2 jacks 105 for matching Type-C interfaces 4 and 2 jacks 105 for matching USB-A interfaces 5. The USB interfaces are distributed in a single row in a length direction of the face plate 103 of the socket. A length direction of the USB interface is parallel to a width direction of the face plate 103 of the socket. With reference to FIG. 2, the upper cover 101 is provided with a recess 106. A baffle 107 matching the recess 106 is arranged on the base 102. The fixation plate 2 is arranged between the recess 106 and the baffle 107. The fixation plate 2 may be fixed in the recess 106 by means of a bolt or erected on the baffle 107. The baffle 107 is fixed in the recess 106 through a fixation relation between the upper cover 101 and the base 102. FIG. 2 shows an example of the fixation plate 2. In the example, the fixation plate 2 is made of metal material and includes wing plates 201 arranged at two ends of the housing 1. Parts of the wing plates 201 extend out of the housing 1. One or several holes are provided on the wing plates 201 such that the fixation plate 2 is fixed to a mounting groove reserved on a wall by means of a bolt, etc. The wing plates 201 are connected to each other by means of a web strip 204 having a width less than that of the wing plate 201. The web strip 204 is arranged on one side or two sides of the USB interface to avoid a position of the USB interface. The wing plate 201 may also be connected by means of a web. The USB interface penetrates the web by punching a hole at a corresponding position. A longitudinal support plate 202 is connected to the wing plate 201. With reference to FIG. 4, the longitudinal support plate 202 is arranged on an inner side of an inner wall of the housing 1, the longitudinal support plate 202 is L-shaped, and two ends of the mounting plate 3 are erected on a flange of one longitudinal support plate 202, such that the mounting plate 3 is arranged at the upper portion of the cavity 104 of the housing 1.

In the above examples, with reference to FIGS. 2 and 4, a longitudinal connection plate 203 is further arranged on one side of the longitudinal support plate 202 of the fixation plate 2. The longitudinal connection plate 203 is provided with a hole to be fixed to the housing 1 by means of a bolt. The longitudinal connection plate 203 may not be arranged. The longitudinal support plate 202 may be arranged close to the inner wall of the housing 1 by lengthening a width of the flange of the longitudinal support plate 202, and the longitudinal support plate 202 is fixed to the housing 1 by means of a bolt.

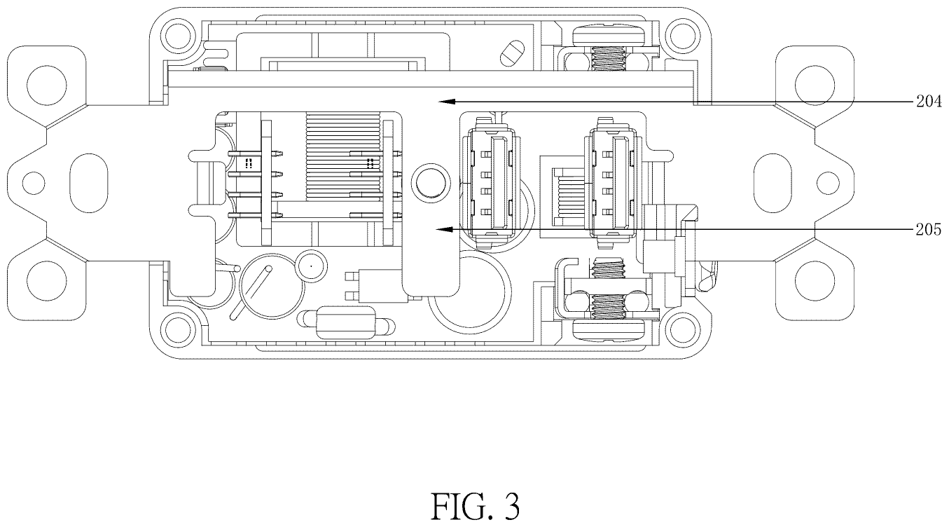

In the above example, with reference to FIGS. 2 and 3, a fixation strip 205 is vertically connected to a middle of the web strip 204. The fixation strip 205 is arranged in a gap between the two USB interfaces. Holes are provided at a middle of the mounting plate 3 and a corresponding position of the fixation strip 205. Bolts pass through the holes on the mounting plate 3 and the fixation strip 205 for fixation. A fixation ring 6 having an appropriate length is arranged between the mounting plate 3 and the fixation strip 205. An upper end and a lower end of the fixation ring 6 are respectively in clamped fit with the fixation strip 205 and the mounting plate 3. In the above example, the mounting plate 3 is erected on the longitudinal support plate 202. The mounting plate 3 and the longitudinal support plate 202 may not be fixed. Therefore, on the one hand, a force is applied between the USB interface and the jack 105 of the face plate 103. On the other hand, steadiness is not enough. However, according to the example, not only mounting steps are simplified, but also the mounting plate 3 and the USB interface are firmly fixed.

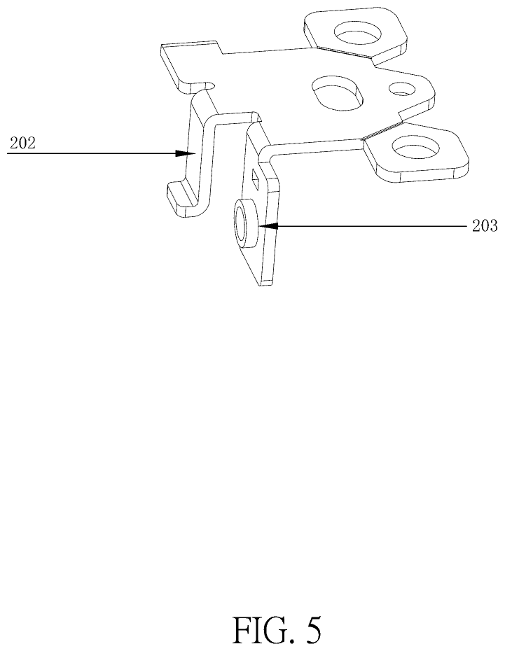

With reference to FIG. 5, as another example of the fixation plate 2, an independent fixation plate 2 may be arranged on each of two sides of the housing 1. The fixation plate 2 is fixed to one side of the housing 1. The flange of the longitudinal support plate 202 may be fixed to an end of the mounting plate 3 in a manner of welding or bolt.

In the above example, with reference to FIG. 4, the base 102 includes a bottom plate 108. A plurality of heat emission holes 109 are provided on the bottom plate 108 and a wall plate of a lower side of the base 102. The heat emission hole 109 is strip-shaped. The plurality of heat emission holes 109 form an array. The printed circuit board 7 and the component are mounted in the cavity 104 of the housing in a suspended manner. The printed circuit board 7 is spaced apart from the bottom plate 108 by a predetermined length. A gap is provided between the component and the mounting plate 3. Several support columns may be arranged between the printed circuit board and the bottom plate 108.

The above examples are merely preferred examples of the present disclosure, and are not intended to limit the present disclosure in any form. Although the present disclosure is disclosed as above by using the preferred examples, these examples are not used for defining the present disclosure. Those skilled in the art can make certain alterations or modifications by using the technical content disclosed above without departing from the scope of the technical solution of the present disclosure so as to arrive at equivalent examples with equivalent changes. However, any simple amendments, equivalent changes and modifications made to the above examples according to the technical essence of the present disclosure without departing from the content of the technical solution of the present disclosure still fall within the scope of the technical solution of the present disclosure.

I claim:

1. A universal serial bus (USB) socket, comprising a housing, a fixation plate, a mounting plate and a USB interface, wherein the fixation plate is fixed on the housing, the USB interface is mounted on the mounting plate, a jack matching the USB interface is provided on a face plate of the housing, the mounting plate is connected to the fixation plate, such that the mounting plate is connected to an upper portion of a cavity of the housing, and a printed circuit board is arranged in the cavity of the housing below the mounting plate.

2. The USB socket according to claim 1, wherein the fixation plate comprises a longitudinal support plate, the longitudinal support plate is L-shaped, the longitudinal support plate is arranged on an inner side of an inner wall of the housing, and an end of the mounting plate is erected on a flange of the longitudinal support plate.

3. The USB socket according to claim 2, wherein the fixation plate comprises a longitudinal connection plate, and the longitudinal connection plate is provided with a hole to be fixed to the housing by means of a bolt.

4. The USB socket according to claim 3, wherein the USB interfaces comprise 2 Type-C interfaces and 2 USB-A interfaces, the USB interfaces are distributed in a single row in a length direction of the face plate of the socket, and a length direction of the USB interface is parallel to a width direction of the face plate of the socket.

5. The USB socket according to claim 4, wherein the fixation plate comprises wing plates arranged at two ends and a web strip connecting the wing plates at the two ends, each wing plate extends out of the housing and is provided with several holes, and the web strip is arranged on one side or two sides of the USB interfaces.

6. The USB socket according to claim 5, wherein a fixation strip is connected to the web strip, and the mounting plate is fixedly connected to the fixation strip.

7. The USB socket according to claim 5, wherein the fixation strip and the mounting plate are provided with corresponding holes, bolts pass through the holes on the mounting plate and the fixation strip for fixation, a fixation ring is arranged between the mounting plate and the fixation strip, the fixation ring is in threaded connection to the bolts, an upper surface of the fixation ring is in clamped fit with a lower surface of the fixation strip, and a lower surface of the fixation ring is clamped fit with an upper surface of the mounting plate.

8. The USB socket according to claim 4, wherein the housing comprises an upper cover and a base detachably fixed to the upper cover, a recess is formed on the upper cover, a baffle matching the recess is arranged on the base, and the fixation plate is arranged between the recess and the baffle.

9. The USB socket according to claim 8, wherein the base comprises a bottom plate, a plurality of heat emission holes are provided on the bottom plate and a wall plate of a lower side of the base, the printed circuit board is mounted in the cavity in a suspended manner, and the printed circuit board is spaced apart from the bottom plate by a predetermined length.

10. The USB socket according to claim 9, further comprising a component connected to the printed circuit board, wherein a gap is provided between the component and the mounting plate.
